(19) United States
(12) Patent Application Publication
(10) Pub. No.: US 2005/0131126 A1
(43) Pub. Date: Jun. 16, 2005

(54) Production of polymer nanocomposites using supercritical fluids

(76) Inventors: Kumin Yang, Hopewell, NJ (US); Rahmi Ozisik, Niskayuna, NY (US)

Correspondence Address: ARLEN L. OLSEN;SCHMEISER, OLSEN & WATTS, 3 LEAR JET LANE, SUITE 201, LATHAM, NY, 12110, US

(21) Appl. No.: 10/787,530

(22) Filed: Feb. 26, 2004

Related U.S. Application Data
(60) Provisional application No. 60/450,549, filed on Feb. 27, 2003.

(51) Int. Cl. C08K 3/34

(52) U.S. Cl. 524/445

(57) ABSTRACT

A method and system of forming a polymer nanocomposite. A layered clay and polymer are selected wherein |Sₚ−S_{scf}|>|S_{c}−S_{scf}| and |S_{c}−S_{scf}|≦2.0 (cal/cm³)^{0.5} are satisfied. Sₚ, S_{c}, and S_{scf} is a solubility parameter of the polymer, clay, and a supercritical fluid (SCF), respectively. The polymer and clay are mixed to form a polymer-clay mixture. The polymer-clay mixture is melted to form a polymer-clay melt. The polymer-clay melt is initially contacted with the SCF while the SCF is subject to an initial pressure exceeding the critical pressure of the SCF and to a temperature exceeding the critical temperature of the SCF. The polymer-clay melt is further contacted with the SCF while the SCF is at a lower pressure below the critical pressure of the SCF to exfoliate the clay to form the nanocomposite having the exfoliated clay being substantially dispersed throughout the polymer of the polymer-clay.

### BACKGROUND OF THE INVENTION

1. Field of Invention

The present invention relates to a method for production of reinforced polymer nanocomposites comprising a polymer matrix having dispersed therein swellable clays. In particular, the present invention relates to the reinforced polymer composites having particular properties and the method for its production using preferentially selected polymers, supercritical fluids, and clay intercalants.

2. Related Art

Methods have been developed to facilitate the exfoliation of clays in polymer-clay mixtures to generate polymer nanocomposite compositions. However, none of the existing methods efficiently disperse the clay within the polymer. Therefore, a need exists for an exfoliation method for polymer-clay mixtures that will produce polymer nanocomposites having efficient dispersion of the clay throughout the polymer nanocomposite.

### SUMMARY OF THE INVENTION

The present invention provides a method for the production of polymer nanocomposites which overcomes the aforementioned deficiencies and others inter alia provides a method for maximum and efficient dispersion of the clay throughout the reinforced polymer.

One aspect of the present invention is a method of forming a polymer nanocomposite comprising the steps of: selecting a clay having a layered structure and a polymer, said selecting satisfying |Sₚ−S_{scf}>|S_{c}−S_{scf}| and |S_{c}−S_{scf}|≦2.0 (cal/cm³)^{0.5}, wherein Sₚ is a solubility parameter of the polymer, S_{c} is a solubility parameter of the clay; and S_{scf} is a solubility parameter of a supercritical fluid (SCF); mixing the polymer and the clay to form a polymer-clay mixture; melting the polymer-clay mixture to form a polymer-clay melt; initially contacting the polymer-clay melt with the SCF while the SCF is subject to an initial pressure exceeding the critical pressure of the SCF and to a temperature exceeding the critical temperature of the SCF; and after said initially contacting step, further contacting the polymer-clay melt with the SCF while the SCF is subject to a lower pressure that is less than the critical pressure of the SCF so as to exfoliate the clay to form the nanocomposite having the exfoliated clay being substantially dispersed throughout the polymer-clay melt.

A second aspect of the present invention is a system for forming a polymer nanocomposite, comprising: a polymer-clay melt of a clay having a layered structure and a polymer; and a supercritical fluid (SCF) in physical contact with the polymer-clay melt, wherein the clay, the polymer, and the SCF collectively satisfy |Sₚ−S_{scf}>|S_{c}−S_{scf}| and |S_{c}−S_{scf}|≦2.0 (cal/cm³)^{0.5}, and wherein Sₚ is a solubility parameter of the polymer, S_{c} is a solubility parameter of the clay; and S_{scf} is a solubility parameter of the SCF.

### BRIEF DESCRIPTION OF THE DRAWINGS

The features of the present invention will best be understood from a detailed description of the invention and an embodiment thereof selected for the purpose of illustration and shown in the accompanying drawing in which:

FIG. 1 depicts a process schematic for mixing a polymer and clay, in accordance with embodiments of the present invention;

FIG. 2 depicts a process schematic for melting the polymer-clay mixture, in accordance with embodiments of the present invention;

FIG. 3 depicts a table of solubility parameters for polymers, supercritical fluids, and clays, in accordance with embodiments of the present invention;

FIG. 4 depicts dispersion curves denoting the degree of nonuniformity of a distribution of polymer particles in a polymer matrix, in accordance with embodiments of the present invention;

FIG. 5 is a flow chart of a method for making a polymer nanocomposite, in accordance with embodiments of the present invention;

FIG. 6 depicts an exfoliated polymer nanocomposite, in accordance with embodiments of the present invention; and

FIGS. 7A and 7B depict an extruder of FIG. 2 along with associated pressure profiles, in accordance-with embodiments of the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc. . . . , and are disclosed simply as an example of an embodiment. The features and advantages of the present invention are illustrated in detail in the accompanying drawing, wherein like reference numeral refer to like elements throughout the drawings. Although the drawings are intended to illustrate the present invention, the drawings are not necessarily drawn to scale.

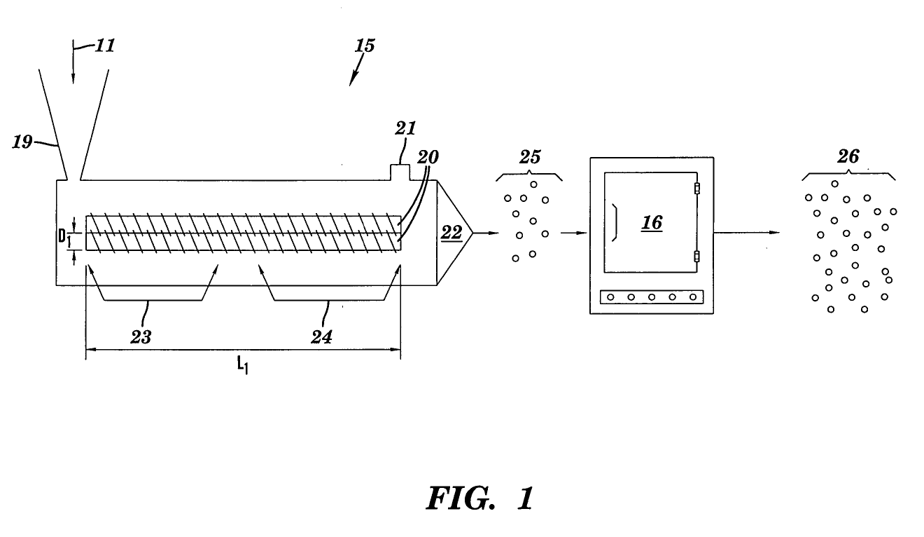

FIG. 1 depicts a process schematic for mixing a polymer and a clay comprising a fully intermeshing, co-rotating twin extruder 15 and a convection oven 16, in accordance with an embodiment of the present invention. The clay has a layered structure (e.g., a clay gallery). The extruder 15 may be a model such as the ZSK 30, Werner & Pfleiderer, and the like. The twin screw extruder 15 comprises an extruder hopper 19, screws 20, a vacuum port 21, and an extruder die 22. The length (L₁) to diameter (D₁) ratio (L₁I/D₁) of the screw 20 may be in a range of 20 to 50 (e.g., 30).

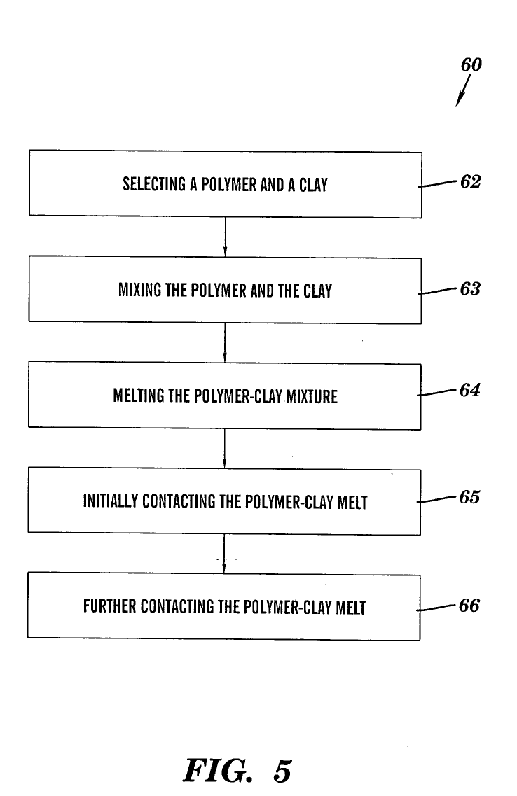

As shown in FIG. 1 and the step 63 of the FIG. 5, namely mixing the polymer and the clay to form a polymer-clay mixture, the step 63 is performed via the extruder 15. A mixture 11 of the polymer and the clay is dry-blended and fed into the extruder 15 via the extruder hopper 19 along with thermal stabilizers and lubricants. The ratio of polymer to clay in the mixture may be in a range of from about 50/50 percent to about 99/1 percent, by weight. Alternatively, the polymer and clay may be fed into the extruder 15 separately giving a final percent by weight of the polymer-clay mixture ranging from about 50/50 percent to about 99/1 percent by weight.

The polymer-clay mixture is kneaded in the first kneading block zone 23 with complete melting of the polymer upon exiting the zone 23. The polymer-clay mixture then enters the second kneading zone 24 where mechanical forces exerted by the extruder screws 20 of the extruder 15 disperse the clay within the polymer-clay mixture. As the polymer-clay mixture exits the kneading zone 24, a vacuum is applied to the extruder 15 via the vent 21 to remove any volatiles that may be present in the polymer-clay mixture. The polymer-clay mixture then passes through the extruder die 22 preforming the mixture into polymer-clay pellets 25. The pellets 25 are dried at a temperature from about 65° C. to about 85° C. for about 10 hrs to about 18 hrs in the convection oven 16 affording dried pellets 26. The extruder 15 operates at a temperature from about 200° C. to about 250° C., with a screw speed from about 200 rpm to about 500 rpm, and a throughput from about 10 kg/hr to about 400 kg/hr. The extruder die 22 operates at a temperature from about 200° C. to about 270° C.

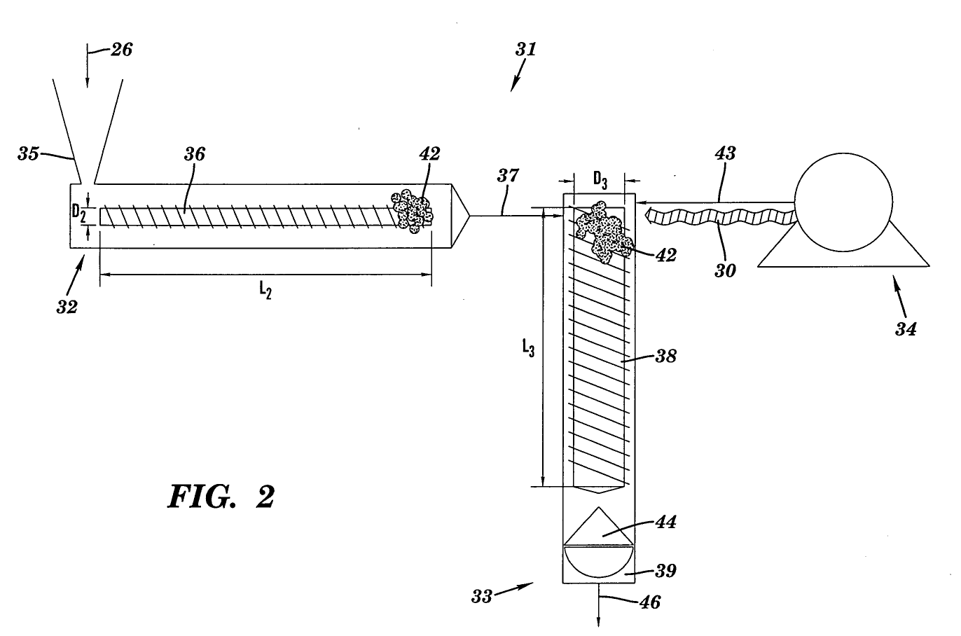

FIG. 2 depicts a process schematic for melting the polymer-clay mixture, i.e. polymer-clay pellets 26 and initially contacting a polymer-clay melt 42, with a SCF 30 using a tandem single screw extrusion setup 31, in accordance of the present invention. The setup 31 comprises a primary single screw extruder 32, a secondary single screw extruder 33, and a positive displacement pump 34. The primary extruder 32 further comprises an extruder hopper 35, a single screw 36, and a delivery attachment 37. The length to diameter ratio (L₂/D₂) of the screw 36 may be in a range of 15 to 30 (e.g., L₂=32.3 inches, D₂=1.5 inches, L₂/D₂=21.5). The extruder 32 may have a compression ration of, inter alia, 2.5. The secondary single screw extruder 33 comprises a single screw 38, an extruder die 39, a torpedo type breaker plate 44. The length to diameter ratio (L₃/D₃) of the screw 38 maybe in a range of 5 to 15 (e.g., L₃=17.2 inches, D₃=2.0 inches, L₃/D₃=8.6).

As shown in FIG. 2 and the step 64 of FIG. 5, namely melting said polymer-clay mixture to form a polymer-clay melt, the polymer-clay pellets 26 are fed into the extruder 32 via the extruder hopper 35. The single screw 36 rotates from about 20 rpm to about 100 rpm. As the pellets 26 pass along the single screw 36, the pellets 26 are heated from about 170° C. to about 250° C. melting the pellets 26 resulting in a polymer-clay melt 42.

As shown in FIG. 2 and the step 65 of FIG. 5, namely initially contacting the polymer-clay melt 42 with the SCF 30 while the SCF is subject to an initial pressure exceeding the critical pressure of the SCF 30 and to a temperature exceeding the critical temperature of the SCF 30, the melt 42 then is delivered to the secondary single screw extruder 33 through the delivery attachment 37, in accordance with the present invention. The secondary extruder 33 operates from about 20 rpm to about 100 rpm. The positive displacement pump 34 injects the SCF 30 into the upstream portion of the extruder 33, via an injection valve assembly 43. Injection of the SCF 30 occurs at a pressure from about 1,000 to about 3,500 pounds per square inch (psi) and at a speed from about 1.0 ml/min to about 10.0 ml/min.

When the SCF 30 is injected into the extruder 33, a pressure gradient is created within the extruder 33. An upstream pressure from about 1,000 psi to about 3,500 psi exists while a downstream pressure from about 500 psi to about 3,000 psi is initially maintained by the extruder die 39. The extruder die 39 is able to control and maintain the pressure within the extruder 33 from about 500 psi to about 3,500 psi. Due to the pressure gradient, the SCF 30 depressurizes along the extruder screw 38 and contacts the polymer-clay melt 42.

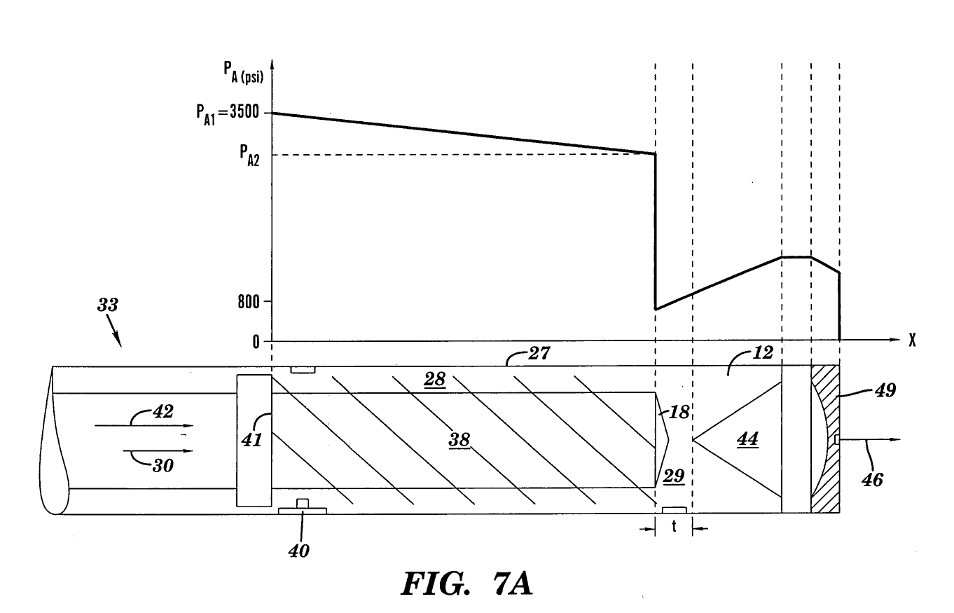

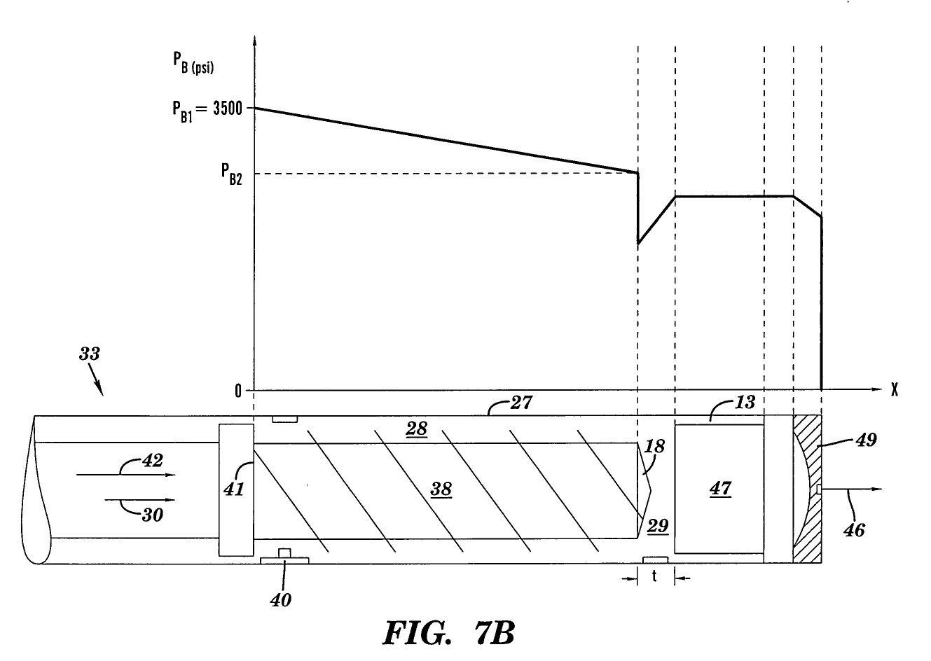

The SCF 30 preferentially migrates toward the clay gallery of the polymer-clay melt 42 because the SCF 30 is more soluble or thermodynamically miscible toward the clay than toward the polymer of the polymer-clay melt 42. The preferential migration of the SCF 30 toward the clay results in the clay being dispersed throughout the polymer-clay melt 42, i.e. exfoliation of the clay when the pressure is less than the critical pressure of the SCF 30. As the SCF 30 and the polymer-clay melt 42 travel through the extruder 33, the polymer-clay melt 42 is exfoliated and mixed as will be described infra in conjunction with FIGS. 7A and 7B. After exfoliation, the polymer-clay melt 42 is extruded via the extruder die 39 and exits the extruder die 33, resulting in a polymer nanocomposite 46 having the clay substantially dispersed throughout the polymer nanocomposite.

Using a co-rotating twin screw extruder and a tandem single screw extrusion line, as previously described, to form polymer nanocomposites is not meant to limit the scope of the production process in an embodiment of the present invention. Polymer nanocomposites can be produced using the co-rotating twin screw extruder and the tandem single screw extrusion line, the co-rotating twin screw extruder, the tandem single screw extruder, individually and combinations thereof in accordance with the method and system of the present invention.

FIG. 7A depicts the secondary extruder 33 of FIG. 2 along with an exemplary pressure profile P_{A} within the extruder 33, in accordance with embodiments of the present invention. The extruder 33 includes the torpedo type breaker plate 44. As shown in FIG. 7A, the polymer-clay melt 42 enters the extruder 33 at (or in the vicinity of) entrance 40 and the resulting polymer nanocomposite 46 exits the extruder 33 at the exit surface 49. The SCF 30 also enters the extruder 33 at (or in the vicinity of) entrance 40. Within the extruder 33, the SCF 30 is subject to the pressure P_{A} whose profile is depicted in FIG. 7A. The pressure to which the SCF 30 in subjected at or in the vicinity of entrance 40, and the pressure P_{A1} which the SCF 30 in subjected at the end 41 of the screw 38, is above the critical pressure P_{CRIT} of the SCF 30. The temperature to which the SCF 30 in subjected in the vicinity of entrance 40, and the temperature at which the SCF 30 in subjected at the end 41 of the screw 38, is above the critical temperature of the SCF 30. Therefore, the SCF 30 is in its supercritical state at or in the vicinity of the entrance 40 and at the end 41 of the screw 38.

In the example of FIG. 7A, P_{A1}=3500 psi. For illustrative purposes, it is assumed that the P_{CRIT}=3000 psi. The pressure P_{A} decreases along the screw 38 from P_{A1} to P_{A2}, wherein P_{A2} is the pressure at the end 18 of the screw 38. Due to contact between the clay and the SCF 30 as facilitated by satisfying Equations (7)-(8), exfoliation of the clay in the polymer-clay melt 42 occurs when the pressure P_{A} is below P_{CRIT}. Thus if P_{A2}<P_{CRIT} (i.e., P_{A2}<3000 psi wherein P_{CRIT}=3000 psi) then the exfoliation will occur in region 28 along the portion of the screw 38 in which P_{A1}<P_{CRIT}. Region 28 exists between the screw 38 and the exterior surface 27 of the extruder 33. Thus if P_{A2}<P_{CRIT}, then a pressure of P_{CRIT} and less than P_{CRIT} exists in region 28.

However if P_{A2}≧P_{CRIT}, then the pressure exceeds P_{CRIT} throughout region 28 and exfoliation will occur exclusively between the end 18 of the screw 38 and the exit surface 49 where the pressure is less than P_{CRIT}. Thus, the pressure is reduced to P_{CRIT} at some location between the end 18 of the screw 38 and the exit surface 49. Note that the pressure profile P_{A} may have continuous portions (e.g., in region 28) and also be essentially discontinuous at discrete locations such as at the end 18 of the screw 38.

The value of P_{A2} relative to the pressure P_{A1} at the end 41 of the screw 38 may be controlled by the volume of region 28. |P_{A2}−P_{A1}| is a monotonically decreasing function of the volume in region 28. Moreover, if the thickness (t) of the region 29 is diminished, then the magnitude of the pressure drop in region 29 in the vicinity of the end 18 of the screw 38 will be correspondingly reduced, so that the pressure drop in region 29 in the vicinity of the end 18 can be made as small as desired. Indeed, if the volume in region 28 is made sufficiently small to cause P_{A2}≧P_{CRIT} and if the thickness (t) of the region 29 is made sufficiently small, then it may be possible to constrain the pressure P_{A} to be above P_{CRIT} throughout the extruder 33, such that the exfoliation of the clay in the polymer-clay melt 42 occurs entirely outside of the extruder 33. Thus for the case of exfoliation of the clay occurring entirely outside of the extruder 33, the pressure is above P_{CRIT} throughout the extruder 33 and the SCF 30 is subject to a pressure below P_{CRIT} after exiting the extruder 33 at the exit surface 49. Therefore, the user of the present invention may design the extruder 33 to adjust the pressure P_{A} profile such that the exfoliation of the clay in the polymer-clay melt 42 occurs wherever desired, such as along a portion of the screw 38, between the end 18 of the screw 38 (a volume 12) and the exit surface 49, outside the extruder 33, etc.

FIG. 7B depicts FIG. 7A with the torpedo breaker plate 44 replaced by a plug type breaker plate 47, in accordance with embodiments of the present invention. As shown in FIG. 7B and the step 66, after said initially contacting step, further contacting the polymer-clay melt with the SCF while the SCF is subject to a lower pressure that is less than the critical pressure of the SCF so as to exfoliate the clay to form the nanocomposite having the exfoliated clay being substantially dispersed throughout the polymer-clay melt, the pressure profile in FIG. 7B is denoted as P_{B}.

The pressure P_{B} in FIG. 7B may be adjusted to control exfoliation of the clay in the polymer-clay melt 42 similar to the manner in which the pressure P_{A} in FIG. 7A may be adjusted to control said exfoliation, except that the volume 13 around the plug type breaker plate 47 in FIG. 7B may be substantially smaller than the volume 12 around the torpedo type breaker plate 44 in FIG. 7A. Due to the relatively smaller volume 13 in FIG. 7B as compared with the volume 12 in FIG. 7A, which facilitates a tendency toward higher pressure in the volume 13 than in the volume 12, it is easier to maintain P_{A} above P_{CRIT} throughout the extruder 33 of FIG. 7A than to maintain P_{B} above P_{CRIT} throughout the extruder 33 of FIG. 7B. Accordingly, it is easier to design the extruder 33 to have the exfoliation of the clay in the polymer-clay melt 42 occurring exclusively outside of the extruder 33 in the embodiment of FIG. 7B than in the embodiment of FIG. 7A.

A necessary condition exists for efficient exfoliation of the polymer-clay mixture of the present invention and any polymer-clay mixture in general. The SCF 30 must preferentially migrate into the clay gallery of the polymer-clay mixture rather than migrate into the polymer matrix. Prior art does not address the migration phenomena. The SCF 30 is incorrectly assumed in the prior art to be in the clay gallery. Prior art neither provides any theoretical or experimental justification for the presence of the SCF 30 in the clay gallery nor explain or describe why such an environment, promoting preferential migration of a SCF 30, would even exist. The preferential migration of the SCF 30 into the clay gallery rather than the polymer matrix is dependent upon satisfying the solubility relationships of Equations (7)-(8), described infra.

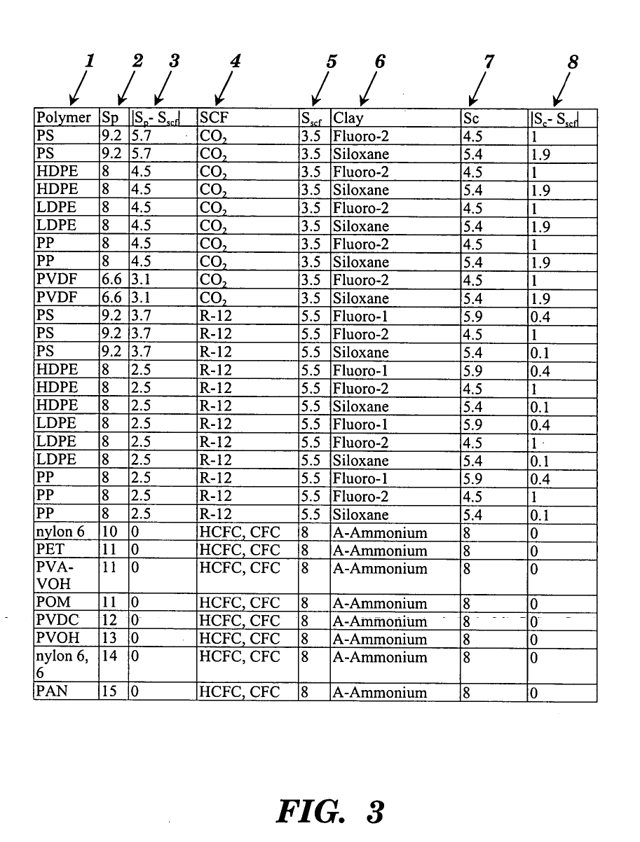

FIG. 3 depicts a table of solubility parameter values and absolute values of the difference of the solubility parameter values for polymers, supercritical fluids (SCF), and clays. Column 1 is a listing of polymers with column 2 listing the solubility parameter of the polymers (Sₚ). Column 4 is a listing of SCFs with column 5 listing the solubility parameter of the SCF (S_{scf}). Column 6 is a listing of clays with column 7 listing the solubility parameter of the clays (S_{c}). Column 3 is a listing of values resultant from the argument |Sₚ−S_{scf}|. Column 8 is a listing of values resultant from the argument |S_{c}−S_{scf}|. All solubility parameter values are given in units of (cal/cm³)^{0.5}.

The abbreviations for the polymers, SCFs, and clays are listed in FIG. 2 are explained below:

Polymer

| | |
|---|---|
| PS | Polystyrene |
| HDPE | High Density Polyethylene |
| LDPE | Low Density Polyethylene |
| PP | Poly(propylene) |
| PVDF | Poly(vinylidene fluoride) |
| PET | Poly(ethylene teraphthalate) |
| PVA-VOH | Poly(vinyl acetate-co-vinyl alcohol) |
| POM | Poly(acetal) |
| PVDC | Poly(vinylidene chloride) |
| PVOH | Poly(vinyl alcohol) |
| PAN | Poly(acrylonitrile) |

Clay

| | |
|---|---|
| Fluoro-1 | Aliphatic fluorocarbons |
| Fluoro-2 | Perfluoroalkylpolyethers |
| Siloxane | Quarternary ammonium termintated |
| | poly(dimethylsiloxane) |
| A-Ammonium | alkyl quarternary ammonium |

Supercritical Fluid (SCF)

| | |
|---|---|
| CO₂ | Carbon dioxide |
| R-12 | CF₂Cl₂ |

The solubility parameter (S) for organic liquids varies with temperature as shown by Eq. 1

$$S = \sqrt{\frac{Δ H - RT}{V}} \qquad ( 1 )$$

where ΔH is the molar enthalpy of vaporization, R is the gas constant, T is the temperature in Kelvin, and V is the molar volume. For gases with low critical temperatures such as N₂, He, H₂, and O₂, the solubility of the gases increase with temperature. Conversely for gases with high critical temperatures such as CO₂, the solubility decreases with temperature.

The solubility parameter of a polymer, a clay, or liquid can be calculated using the simple but powerful group contribution method as shown in Eq. (2)

$$S = \frac{{\sum }_{i = 1}^{j} {E}_{i}}{{\sum }_{i = 1}^{j} {V}_{i}} \qquad ( 2 )$$

where Eᵢ is the molar attraction constant and Vᵢ is the molar volume constant for component i. Using the group contribution method, to a first approximation, the solubility parameters for many polymers can be estimated. For example, the solubility parameter for poly(methylmethacrylate) (PMMA)

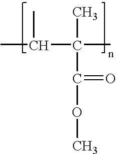

can be determined using Eq. (2) above and Table 1 below.

TABLE 1
Molar Attraction and Volume Constants

| Group | E [cal * cm³)^{0.5}/mol] | V (cm³/mol) |
|---|---|---|
| CH3 | 218 | 31.8 |
| CH2 | 132 | 16.5 |
| <C> | −97 | −14.8 |
| COO | 298 | 19.6 |

$S = \frac{132 + 2 ( 218 ) - 97 + 298}{16.5 + 2 ( 31.8 ) - 14.8 + 19.6} = 9.1$

The solubility parameter of PMMA is determined to be 9.1 (cal/cm³)^{0.5} calculated by the group contribution method.

A supercritical fluid is any substance above its critical temperature and critical pressure. Supercritical fluids exhibit physicochemical properties intermediate between those of liquids and gases, i.e. solubilities approaching a liquid phase and diffusivities approaching a gas phase. The solubility parameter for CO₂ has been determined to be 3.5 (cal/cm³)^{0.5} at a typical processing temperature of 177° C. and a pressure of 3,500 psi. At a given pressure and temperature, the CO₂ solubility parameter was calculated with the help of molecular dynamics software, Materials Studio v2.2 (Accelrys, Inc.). The calculated value of 3.5 (cal/cm³)^{0.5} is in excellent agreement reported literature values. Table 2 lists properties of hydorchlorofluorocarbons (HCFCs) and chlorofluorocarbons (CFCs).

TABLE 2

| Refrigerant | Chemical | Critical Points | | | S |
|---|---|---|---|---|---|
| Codes | Formula | T_{c} | P_{c} | ρ_{c} | (cal/cm³)^{0.5} |
| R-11 | CFCl₃ | 198 | 4.41 | 0.5539 | 7.6 |
| R-12 | CF₂Cl₂ | 112 | 4.13 | 0.5572 | 5.5 |
| R-21 | CHFCl₂ | 178 | 5.18 | 0.5251 | 8.3 |
| R-22 | CHF₂Cl | 96 | 4.97 | 0.5209 | 8.3 |
| R-112 | C₂Cl₄F₂ | N/A | N/A | N/A | 7.8 |
| R-123 | CHCl₂CF₃ | 184 | 3.67 | N/A | 7.8 |
| R-142b | C₂H₃ClF₂ | 137 | 4.12 | 0.4351 | 8.1 |
| — | CO₂ | 31 | 7.38 | 0.4682 | — |

From table 2, the average solubility parameter for HCFC and CFC is 8.0 (cal/cm³)^{0.5} with R-12 being an exception.

The solubility parameter (Sₓ), is related to the Gibbs free energy of mixing equation, Eq. 3
ΔG=ΔH−TΔS (3)
where ΔG is the Gibbs free energy of mixing, ΔH is the enthalpy of mixing, and ΔS is the entropy of mixing. For a binary system, the heat of mixing per unit volume is
ΔH/V=(S₁−S₂)Φ₁Φ₂ (4)
where S is the solubility parameter and Φ is the volume fraction. For Eq. 3 to be less than zero, i.e. thermodynamically miscible system, the solubility parameters S₁ and S₂ of Eq. 4 must be close to each other.

For systems that exhibit strong interactions between system components, such as hydrogen bonding, if the difference between the solubility parameters of the system components is less than 2.0 (cal/cm³)^{0.5}, solubility can be expected. Strong solubility/affinity between system components would have solubility values that lie between 1.0 (cal/cm³)^{0.5} and 2.0 (cal/cm³)^{0.5}. The strongest solubility/affinity system components would have solubility values that are 1.0 (cal/cm³)^{0.5} or less. This concept can be represented mathematically by the Equations (5) and (6).
|S₁−S₂|≦2.0 (5)
|S₁−s₂|≦1.0 (6)

Applying Equations (5) and (6) to the preferential migration of the SCF into a clay gallery, Equations (7) and (8) can be derived to represent a condition that must be satisfied if preferential migration of the SCF into a clay gallery is to occur.
|S₁−S₂|≦2.0 (7)
A second condition that must be satisfied for preferential migration of the SCF into a clay is represented by Eq. (8)
|Sₚ−s_{scf}|>|S_{c}−S_{scf}| (8)
where S_{c}, Sₚ, and S_{scf} are the solubility parameter of the clay, the polymer, and the supercritical fluid respectively.

As shown in FIG. 3 and the step 62 of FIG. 5, selecting a clay having a layered structure and a polymer, said selecting satisfying |Sₚ−S_{scf}>|S_{c}−S_{scf}| and |S_{c}−S_{scf}|≦2.0 (cal/cm³)^{0.5}, wherein Sₚ is a solubility parameter of the polymer, S_{c} is a solubility parameter of the clay; and S_{scf} is a solubility parameter of a supercritical fluid (SCF), of the method 60, to be used in the production of a polymer nanocomposite, the polymer must satisfy Equations (7) and (8).
|S_{c}−S_{scf}|≦2.0 (7)
|Sₚ−S_{scf}|>|S_{c}−S_{scf} | (8)

A candidate polymer for use in a polymer nanocomposite may be determined by substituting in Equations (7) and (8) the corresponding solubility parameter as well as the solubility parameters of the SCF and clay also to be used. If Equations (7) and (8) are satisfied, the polymer is considered to be a candidate polymer for use in a polymer nanocomposite. For example, to determine if PS would make a candidate polymer in a polymer nanocomposite with CO₂ as the SCF and a Fluoro-2 as the clay, the solubility parameters of the aforementioned would be substituted into the Equations (7) and (8). From FIG. 3, the solubility parameter of PS, CO₂, and Fluoro-2 are 9.2, 3.5, and 4.5 respectively. Substitution into Equations (7) and (8) give:
|Sₚ−S_{scf}|>|S_{c}−S_{scf}| |S_{c}−S_{scf}|≦2.0
|9.2−3.5|>|4.5−3.5| |4.5−3.5|≦2.0
5.7>1.0 1.0≦2.0
Having satisfied the Equations (7) and (8), PS is considered to be a candidate polymer for use in a polymer nanocomposite with CO₂ and Fluoro-1 as the SCF and the clay respectively.

Other examples of candidate polymers that satisfy Equations (7) and (8) are listed below with sample calculations. Solubility parameter values are from FIG. 3.

High Density Polyethylene (HDPE) with CO₂ and Fluoro-2
|Sₚ−S_{scf}|>|S_{c}−S_{scf}| |S_{c}−S_{scf}|≦2.0
|8.0−3.5|>|4.5−3.5| |4.5−3.5|≦2.0
4.5>1.0 1.0≦2.0

Low Density Polyethylene (LDPE) with R-12 and Fluoro-1
|Sₚ−S_{scf}|>|S_{c}−S_{scf}| |S_{c}−S_{scf}|≦2.0
|8.0−5.5|>|5.9−5.5| |5.9−5.5|≦2.0
2.5>0.4 0.4≦2.0

Poly(vinyl alcohol) (PVOH) with A-Ammonium and CFC |Sₚ−S_{scf}|>|S_{c}−S_{scf}|
|S_{c}−S_{scf}|2.0
|12.6−8.0|>|8.0−8.0| |8.0−8.0|≦2.0
4.6>0.0 0.0≦2.0

A table of candidate polymers for use in polymer nanocomposites along with compatible SCFs and clays is listed below in Table 3. All the polymers listed along with the corresponding variations of compatible SCFs and clays satisfy Equations (7) and (8).

TABLE 3

| Polymer | SCF | Clay |
|---|---|---|
| Type | Type | Type |
| PS | CO₂ | Fluora-2 |
| PS | CO₂ | Siloxane |
| HDPE | CO₂ | Fluoro-2 |
| HDPE | CO₂ | Siloxane |
| LDPE | CO₂ | Fluoro-2 |
| LDPE | CO₂ | Siloxane |
| PP | CO₂ | Fluoro-2 |
| PP | CO₂ | Siloxane |
| PVDF | CO₂ | Fluoro-2 |
| PVDF | CO₂ | Siloxane |
| PS | R-12 | Fluoro-1 |
| PS | R-12 | Fluoro-2 |
| PS | R-12 | Siloxane |
| HDPE | R-12 | Fluoro-1 |
| HDPE | R-12 | Fluoro-2 |
| HDPE | R-12 | Siloxane |
| LDPE | R-12 | Fluoro-1 |
| LDPE | R-12 | Fluoro-2 |
| LDPE | R-12 | Siloxane |
| PP | R-12 | Fluoro-1 |
| PP | R-12 | Fluoro-2 |
| PP | R-12 | Siloxane |
| nylon 6 | HCFC, CFC | A-Ammonium |
| PET | HCFC, CFC | A-Ammonium |
| PVA-VOH | HCFC, CFC | A-Ammonium |
| POM | HCFC, CFC | A-Ammonium |
| PVDC | HCFC, CFC | A-Ammonium |
| PVOH | HCFC, CFC | A-Ammonium |
| nylon 6, 6 | HCFC, CFC | A-Ammonium |
| PAN | HCFC, CFC | A-Ammonium |

If Equations (7) and (8) are not satisfied, the polymer is considered not to be a candidate polymer for use in a polymer nanocomposite. For example, from FIG. 3, the solubility parameter of PS (8.0), A-Ammonium (8.0), and CO₂ (3.5) would be substituted into the Equations (7) and (8).
|Sₚ−S_{scf}|>|S_{c}−S_{scf}| |S_{c}−S_{scf}|≦2.0
|8.0−3.5|>|8.0−3.5| |8.0−3.5|≦2.0
4.5≯1.0 4.5≮2.0
Not having satisfied Equations (7) and (8), PS is not considered to be a candidate polymer for use in a polymer nanocomposite with CO₂ and A-Ammonium as the SCF and the clay respectively.

Other examples of polymers that do not satisfy Equations (7) and (8) are listed below with sample calculations.

LDPE with CO₂ and A-Ammonium
|Sₚ−S_{scf}|>|S_{c}−S_{scf}| |S_{c}−S_{scf}|≦2.0
|8.0−3.5|>|8.0−3.5| |8.0−3.5|≦2.0
4.5≯4.5 4.5≮2.0

Poly(vinyldene fluoride) (PVDF) with CO₂ and A-Ammonium
|Sₚ−S_{scf}|>|S_{c}−S_{scf}| |S_{c}−S_{scf}|≦2.0
|8.0−3.5|>|8.0−3.5| |8.0−3.5|≦2.0
3.1≯4.5 4.5≮2.0

A table of polymers for that would not be candidates for use in polymer nanocomposites along with the SCFs and the clays is listed in Table 4 below.

TABLE 4

| Polymer | SCF | Clay |
|---|---|---|
| PVDF | CO₂ | A-Ammonium |
| HDPE | CO₂ | A-Ammonium |
| LDPE | CO₂ | A-Ammonium |
| PS | CO₂ | A-Ammonium |
| PP | CO₂ | A-Ammonium |
| nylon 6 | CO₂ | A-Ammonium |
| PET | CO₂ | A-Ammonium |
| PVA-VOH | CO₂ | A-Ammonium |
| POM | CO₂ | A-Ammonium |
| PVDC | CO₂ | A-Ammonium |
| PVOH | CO₂ | A-Ammonium |
| nylon 6, 6 | CO₂ | A-Ammonium |
| PAN | CO₂ | A-Ammonium |

In choosing the candidate polymers for the use in polymer nanocomposites, the polymers listed in FIG. 3 and table 3 are not meant to limit the scope of the polymers that may be chosen in an embodiment of the present invention. Any polymer that has a solubility parameter satisfying Equations (7) and (8), whether measured or theoretically calculated, may be used in the method 1 for producing polymer nanocomposites.

The candidate polymers may be selected from a group including but not limited to high density polyethylene, low density polyethylene, nylon 6, nylon 6, 6, poly(acrylonitrile), poly(ethylene terephthalate), poly(acetal), poly(propylene), polystyrene, poly(vinyl acetate-co-vinyl alcohol), poly(vinylidene chloride), poly(vinylidene fluoride), poly(vinyl alcohol), and the like.

As shown in FIG. 3 and the step 62 of FIG. 5, selecting a clay having a layered structure and a polymer, said selecting satisfying Equations (7) and (8).
|S_{c}−S_{scf}|≦2.0 (7)
|S_{c}−S_{scf}|<|Sₚ−S_{scf|} (8)
A candidate clay for use in a polymer nanocomposite may be determined by substituting in Equations (7) and (8) the corresponding solubility parameter of the clay as well as the solubility parameters of the SCF and the polymer also to be used.

If Equations (7) and (8) are satisfied, the clay is considered to be a candidate clay for use in a polymer nanocomposite. For example, to determine if A-Ammonium would make a candidate clay in a reinforced nanocomposite with CFC as the SCF and a nylon-6 as the polymer, the solubility parameters of the aforementioned would be substituted into the Equations (7) and (8). From FIG. 3, the solubility parameter of A-Ammonium, CFC, and nylon-6 are 8.0, 8.0, and 10.1 respectively. Substitution into Equations (7) and (8) give:
|S_{c}−S_{scf}|<|Sₚ−S_{scf}| |S_{c}−S_{scf}|≦2.0
|8.0−8.0|<|10.1−3.5| |8.0−8.0|≦2.0
0.0<6.6 0.0≦2.0
Having satisfied the Equations (7) and (8), A-Ammonium is considered to be a candidate clay for use in a reinforced nanocomposite with CFC and nylon-6 as the SCF and polymer respectively.

Other examples of candidate clays that satisfy Equations (7) and (8) are listed below with sample calculations. The solubility parameter values are from FIG. 3.

Quarternary ammonium terminated PDMS (Siloxane) with R-12 and HDPE
|S_{c}−S_{scf}| |Sₚ−S_{scf}| |S_{c}−S_{scf}|≦2.0
|5.4−5.5|<|8.0−5.5| |5.4−5.5|≦2.0
0.1<2.5 0.1≦2.0

Fluoro-2 with CO₂ and Poly(propylene) (PP)
|S_{c}−S_{scf}|<|S_{c}−S_{scf}| |S_{c}−S_{scf}|≦2.0
|4.5−3.5|<|8.0−3.5| |4.5−3.5|≦2.0
1.0<4.5 1.0≦2.0

A-Ammonium with HCFC and PVOH
|S_{c}−S_{scf}|<|S_{c}−S_{scf}| |S_{c}−S_{scf}|≦2.0
|8.0−8.0|<|12.6−8.0| |8.0−8.0|≦2.0
0.0<4.6 0.0≦2.0

A table of candidate clays for use in polymer nanocomposites along with compatible SCFs and polymers is listed below in Table 5. All the clays listed along with the compatible SCFs and polymers satisfy Equations (7) and (8).

TABLE 5

| Clay | Supercritical Fluid | Polymer |
|---|---|---|
| A-Ammonium | HCFC, CFC | nylon 6 |
| A-Ammonium | HCFC, CFC | PET |
| A-Ammonium | HCFC, CFC | PVA-VOH |
| A-Ammonium | HCFC, CFC | POM |
| A-Ammonium | HCFC, CFC | PVDC |
| A-Ammonium | HCFC, CFC | PVOH |
| Fluoro-1 | R-12 | PS |
| Fluoro-1 | R-12 | HDPE |
| Fluoro-1 | R-12 | LDPE |
| Fluoro-1 | R-12 | PP |
| Fluoro-2 | CO₂ | PS |
| Fluoro-2 | CO₂ | HDPE |
| Fluoro-2 | CO₂ | LDPE |
| Fluoro-2 | CO₂ | PP |
| Fluoro-2 | CO₂ | PVDF |
| Fluoro-2 | R-12 | PS |
| Fluoro-2 | R-12 | HDPE |
| Fluoro-2 | R-12 | LDPE |
| Fluoro-2 | R-12 | PP |
| Siloxane | CO₂ | PS |
| Siloxane | CO₂ | HDPE |
| Siloxane | CO₂ | LDPE |
| Siloxane | CO₂ | PP |
| Siloxane | CO₂ | PP |
| Siloxane | R-12 | PS |
| Siloxane | R-12 | HDPE |
| Siloxane | R-12 | LDPE |
| Siloxane | R-12 | PP |

If Equations (7) and (8) are not satisfied, the clay is not considered to be a candidate clay for use in a polymer nanocomposite. For example, to determine if the clay A-Ammonium is a candidate polymer; the solubility parameter of A-Ammonium (8.0), CO₂ (3.5), and PVDF (6.6) and would be substituted into the Equations (7) and (8).
|S_{c}−S_{scf})<|Sₚ−S_{scf}| |S_{c}−S_{scf}|≦2.0
|8.0−3.5|<|6.6−3.5| |8.0−3.5|≦2.0
4.5≯4.1 4.5≮2.0
Not having satisfied the argument of Equations (7) and (8), A-Ammonium is not considered to be a candidate clay for use in a polymer nanocomposite with CO₂ and PVDF as the SCF and polymer respectively.

Other examples of clays that do not satisfy Equations (7) and (8) are listed below with sample calculations.

A-Ammonium with CO₂ and Nylon 6
|S_{c}−S_{scf}|<|S_{c}−S_{scf}| |S_{c}−S_{scf}|≦2.0
|8.0−3.5|<|10.1−3.5| |8.0−3.5|≦2.0
4.5<6.6 4.5≮2.0

A-Ammonium with CO₂ and PVOH
|S_{c}−S_{scf}|>|Sₚ−S_{scf}| |S_{c}−S_{scf}|≦2.0
|8.0−3.5|>|12.6−3.5| |8.0−3.5|≦2.0
4.5<9.1 4.5≮2.0

A table of clays for that would not be candidates for use in polymer nanocomposites along with the SCFs and polymers is listed below in Table 6.

TABLE 6

| Clay | SCF | Polymer |
|---|---|---|
| A-Ammonium | CO₂ | PVDF |
| A-Ammonium | CO₂ | HDPE |
| A-Ammonium | CO₂ | LDPE |
| A-Ammonium | CO₂ | PS |
| A-Ammonium | CO₂ | PP |
| A-Ammonium | CO₂ | nylon 6 |
| A-Ammonium | CO₂ | PET |
| A-Ammonium | CO₂ | PVA-VOH |
| A-Ammonium | CO₂ | POM |
| A-Ammonium | CO₂ | PVDC |
| A-Ammonium | CO₂ | PVOH |
| A-Ammonium | CO₂ | nylon 6, 6 |
| A-Ammonium | CO₂ | PAN |

In choosing the candidate clays for the use in polymer nanocomposites, the clays listed in FIG. 3 and table 5 are not meant to limit the scope of the clays that may be chosen in an embodiment of the present invention. Any clay that has a solubility parameter satisfying Equations (7) and (8), whether measured or theoretically calculated, may be used in the method 60, for producing polymer nanocomposites.

The use of the term clay is not meant to limit the scope of the type of clay that may be selected for the method 60, producing polymer nanocomposites. The term clay, as used in the present invention, encompass clays that are modified as well as non-modified. Modified clays are clays that have an intercalant coupled to the clay by methods known to one ordinarily skilled in the art. The intercalant may be organic or inorganic in nature, and combinations thereof. The nature of the intercalant defines the nature of the modified clay. For example, a clay having an organic intercalant coupled to the clay is considered to be an organically modified clay. Analogously, a clay having an inorganic intercalant coupled to the clay is an inorganically modified clay. Generally, the solubility parameter of the clay is controlled by the solubility parameter of the intercalant coupled to the clay, i.e. the solubility of the intercalant is representative of the clay as whole.

A clay is but one member of larger category known as swelling material. Swelling materials are comprised of phyllosilicates such as smectite clays; naturally or synthetic, montmorillonite, saponite, hectorite, vermiculite, beidellite, stevensite, and the like. All of which may be used for producing polymer nanocomposites. Any swelling material that has a solubility parameter satisfying Equations (7) and (8), whether measured or theoretically calculated, and is capable of exfoliation by the methods presented in accordance with the present invention, may be used in the method 60, for producing polymer nanocomposites. A filler refers to a group of materials comprising glass fibers, carbon fibers, carbon nanotubes, talc, mica, and the like. Fillers may be used in combination with swelling agents, such as clays, for use in the production of polymer nanocomposites.

In selecting the SCFs for the use in producing polymer nanocomposites, the SCFs listed in FIG. 3 are not meant to limit the scope of the SCFs that may be chosen in an embodiment of the present invention. Any SCF that has a solubility parameter satisfying Equations (7) and (8), whether measured or theoretically calculated, may be used in the method 60, for producing polymer nanocomposites

Examples of SCFs that may be selected include but are not limited to hydrocarbons such as propane, n-butane, iso-butane, n-pentane, iso-pentane, 2,2-dimethylpropane, 1-pentene, cyclopentene, n-hexane, 2-methylpentane, 3-methylpentane, 2,3-dimethylpentane, 2,2-dimethylbutane, 1-hexene, cyclohexane, n-heptane, 2-methylhexane, 2,2-dimethylpentane, 2,3-dimethylpentane, 2,4-dimethylpentane, 3,3-dimethylpentane, 3-ethylpentane, 2,3,3-trimethylbutane, 1-heptene, and the like; alcohols such as methanol, ethanol, 2-propanol, and the like; ketones such as acetone, methylethyl ketone, and the like; ethers such as ethyl ether, isopropyl ether, and the like; chlorinated hydrocarbons such as dichloromethane, trichloromethane, trichloroethylene, tetrachloromethane, 1,2-dichloroethane, and the like; fluorinated hydrocarbons such as tetrafluoromethane, triflouromethane, hexaflouroethane, difluoroethane, tetraflouroethane, and the like; and chlorofluorohydrocarbons such as trichlorofluoromethane, dichlorodifluoromethane, chlorotrifluoromethane, dichlorofluoromethane, chlorodifluoromethane, tetrachlorodifluoroethane, trichlorotrifluoroethane, dichlorotetrafluoroethane, chloropentafluoroethane, dichlorofluoroethane, chlorotetrafluoroethane, chlorodifluoroethane, and the like.

Selecting the polymer, the clay, and the SCF as previously described, to form polymer nanocomposites is not meant to limit the scope of the number of the aforementioned that may be used to form a polymer nanocomposite. For example, two polymers and one clay may be selected satisfying equations (7)-(8) inconjuntion with the SCF to form a polymer nanocomposite in accordance with the method and system of the present invention. Another example may be selecting one polymer and two clays that satisfy equations (7)-(8) inconjunction with the SCF to form a polymer nanocomposite. Polymer nanocomposites can be formed by selecting polymers and the clays satisfying equations (7)-(8) inconjucntion with the SCFs and combinations thereof in accordance with the method and system of the present invention. Generally, one or more clays may be used with one or more polymers in conjunction with one or more SCFs. Generally, each distinct combination of one clay, one polymer, and one SCF must satisfy Equation (7)-(8).

As explained supra, the present invention controls the uniformity of dispersion of the clay within the polymer matrix by adjusting the solubilities Sₚ, S_{c}, and S_{scf} in accordance with Equations (7)-(8). For convenience, Equation (7)-(8) can be rewritten in the following equivalent form:
F₁<1 (9)
F₂≦1 (10)
where
F₁=|S_{c}−S_{scf}|/|Sₚ−S_{scf}| (11)
F₂=|S_{c}−S_{scf}|/2 (12)

The extent to which the clay is uniformly dispersed in the polymer matrix by the exfoliation method of the present invention may be empirically determined as a function of F₁ and F₂ as follows. Let the σ represent the degree of dispersion of the clay within the polymer following the exfoliation. σ may be defined, inter alia, as the standard deviation of the distances between the centroids of the clay particles distributed within the polymer matrix; i.e.,
σ=[Σ_{I}(D(I)−D_{AVE})²/N]^{½} (13)
D_{AVE}=[Σ_{I}D(I)]/N (14)
where N is the number of pairs of clay particles in the polymer matrix, Σ_{I} denotes summation with respect to the index I from I=1 to I=N, D(I) is the distance between centroids of the two clay particles of the I^{th} pair of clay particles in the polymer matrix (I=1, 2, . . . , N), and D_{AVE} is the average of the N distances D(I). Alternatively, D_{AVE} could be computed as a weighted average for any purpose such as, inter alia, to differentiate the importance of different portions of the polymer matrix or to diminish the effect of outliers. The distances D(I) may be determined by measurement, through analysis of the locations of the clay particles within the polymer matrix following the exfoliation. It is not be necessary to analyze all pairs of clay particles in the polymer matrix, and the value of N reflects the number of such pairs of clay particles actually used in the numerical analysis. N should be large enough to assure the desired statistical accuracy in the calculation of σ.

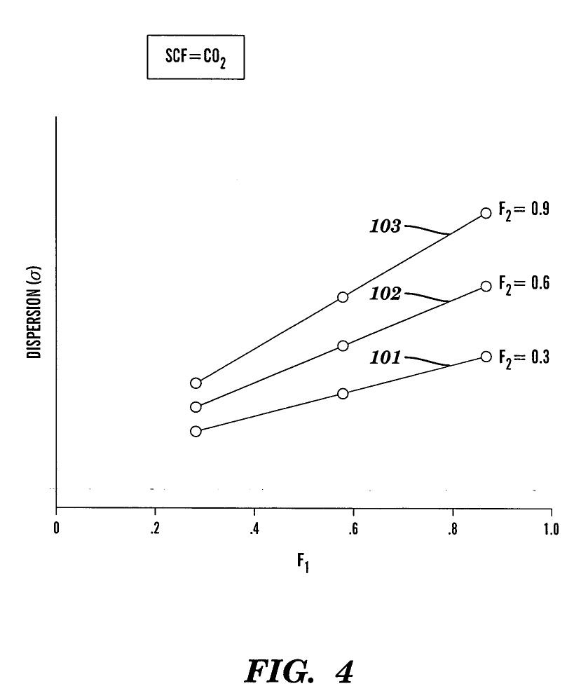

To obtain a as a function of F₁ and F₂, one could vary F₁ while holding F₂ constant. For example, one could select a first SCF (e.g., CO₂) and a first clay such that F₂ is 0.3 and select three different polymers such that F₁ is 0.3, 0.6, and 0.9, respectively, which enables σ to be determined by measurement, resulting in the curve 101 in FIG. 4, in accordance with embodiments with the present invention. Next, one could select the first SCF and a second clay such that F₂ is 0.6 and select another three different polymers such that F₁ is 0.3, 0.6, and 0.9, which enables σ to be determined by measurement, resulting in the curve 102 in FIG. 4. Again, one could select the second SCF and a third clay such that F₂ is 0.9 and select yet another three different polymers, which enables σ to be determined by measurement, resulting in the curve 103 in FIG. 4.

While the curves 101, 102, and 103 are shown in FIG. 4 as linear, the actual shapes of the σ versus F₁ curves 101, 102, and 103 result from the empirically determined values of a for the fixed F₂ and varying F₁. In practice, the curves 102-103 may be either linear or non-linear. Alternatively, each plotted curve could represent σ versus F₂ with F₁ being constant for each curve. In addition, one could repeat the preceding process for a second SCF (e.g., R-12) to obtain another set of curves analogous to the curves 101, 102, and 103 of FIG. 4.

While F₁ has the same set of plotted values (i.e., 0.3, 0.6, 0.9) on each of curves 101-103 in FIG. 4, the selected polymers for curves 101-103 may result in a different set of plotted values of F₁ in each of curves 101-103. Also, the number of plotted points on each of curves 101-103 may be the same number of plotted points (e.g., 3 as shown in FIG. 4) or a different number of plotted points for each curve.

FIG. 5 depicts a flow chart of method 60, forming a polymer nanocomposite comprising: the step 62; selecting a clay having a layered structure and a polymer, said selecting satisfying |Sₚ−S_{scf}|>|S_{c}−S_{scf}| and |S_{c}−S_{scf}|≦2.0, wherein Sₚ is a solubility parameter of the polymer, S_{c} is a solubility parameter of the clay; and S_{scf} is a solubility parameter of a supercritical fluid (SCF); the step 63, mixing the polymer and the clay to form a polymer-clay mixture; the step 64, melting the polymer-clay mixture to form a polymer-clay melt; the step 65, initially contacting the polymer-clay melt with the SCF while the SCF is subject to an initial pressure exceeding the critical pressure of the SCF and to a temperature exceeding the critical temperature of the SCF; and the step 66, after said initially contacting step, further contacting the polymer-clay melt with the SCF while the SCF is subject to a lower pressure that is less than the critical pressure of the SCF so as to exfoliate the clay to form the nanocomposite having the exfoliated clay being substantially dispersed throughout the polymer-clay melt.

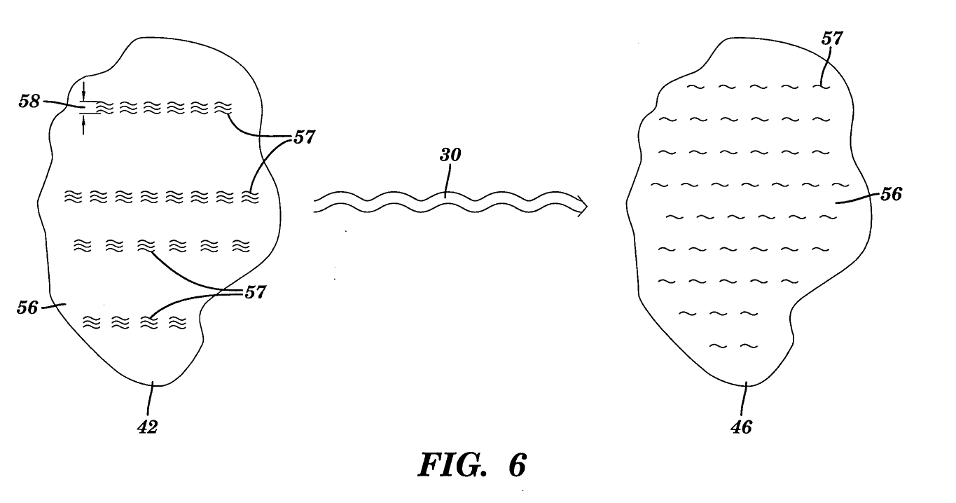

FIG. 6 depicts an embodiment of the present invention, polymer nanocomposite 46 in which the SCF 30 has been removed. The polymer-clay mixture, i.e. the polymer-clay melt 42, comprising a polymer 56 and a layered clay 57, is contacted with the supercritical fluid 30 at the supercritical pressure and the supercritical temperature of the fluid. The SCF 30 preferentially migrates to the clay gallery 58 and exfoliates the clay 57 of the clay gallery 58. The result is a polymer nanocomposite 46 having the clay 57 dispersed uniformly throughout the polymer 56.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included withing the scope of this invention as defined by the accompanying claims.

1. A method of forming a polymer nanocomposite comprising the steps of:
selecting a clay having a layered structure and a polymer, said selecting satisfying

|Sₚ−S_{scf}|>|S_{c}−S_{scf}|

and

|S_{c}−S_{scf}|≦2.0 (cal/cm³)^{0.5},
wherein Sₚ is a solubility parameter of the polymer, S_{c} is a solubility parameter of the clay; and S_{scf} is a solubility parameter of a supercritical fluid (SCF);
mixing the polymer and the clay to form a polymer-clay mixture;
melting the polymer-clay mixture to form a polymer-clay melt;
initially contacting the polymer-clay melt with the SCF while the SCF is subject to an initial pressure exceeding the critical pressure of the SCF and to a temperature exceeding the critical temperature of the SCF; and
after said initially contacting step, further contacting the polymer-clay melt with the SCF while the SCF is subject to a lower pressure that is less than the critical pressure of the SCF so as to exfoliate the clay to form the nanocomposite having the exfoliated clay being substantially dispersed throughout the polymer-clay melt.

2. The method of claim 1, wherein during the initially contacting and further contacting steps the SCF is subject to a pressure which decreases monotonically from the initial pressure to the lower pressure.

3. The method of claim 1, wherein during the initially contacting and further contacting steps the SCF is subject to a pressure which decreases non-monotonically from the initial pressure to the lower pressure.

4. The method of claim 1, wherein during the initially contacting and further contacting steps the SCF is subject to a pressure which varies essentially continuously from the initial pressure to the lower pressure.

5. The method of claim 1, wherein during the initially contacting and further contacting steps the SCF is subject to a pressure which varies essentially discontinuously from the initial pressure to the lower pressure.

6. The method of claim 1, wherein the initially contacting and further contacting steps include flowing the polymer-clay melt and the SCF within an extruder and through a first region along a screw comprised by the extruder and through a second region in the extruder beyond screw such that the polymer-clay melt and SCF exit the extruder at a bounding surface of the second region to a third region outside the extruder.

7. The method of claim 6, wherein the lower pressure exists within the first region.

8. The method of claim 6, wherein the lower pressure does not exist within the first region, and wherein the lower pressure exists within the second region.

9. The method of claim 6, wherein the lower pressure does not exist within the extruder, and wherein the lower pressure exists within the third region.

10. The method of claim 1, wherein during the initially contacting step the SCF preferentially migrates toward the layered structure of the clay.

11. The method of claim 1, wherein mixing the polymer and the clay is performed using a co-rotating twin screw extruder.

12. The method of claim 11, wherein the co-rotating twin screw extruder operates at a temperature range from about 200° C. to about 250° C., a screw speed from about 200 rpm to about 500 rpm, and a throughput from about 10 kg/hr to about 400 kg/hr.

13. The method of claim 11, wherein a die of the co-rotation twin extruder operates at a temperature from about 200° C. to about 270° C.

14. The method of claim 1, wherein the polymer is selected from a group consisting of high density polyethylene, low density polyethylene, nylon 6, nylon 6, 6, poly(acrylonitrile), poly(ethylene terephthalate), poly(acetal), poly(propylene), polystyrene, poly(vinyl acetate-co-vinyl alcohol), poly(vinylidene chloride), poly(vinylidene fluoride), and poly(vinyl alcohol).

15. The method of claim 1, wherein the clay comprises at least one of an aliphatic fluorocarbon, perfluoroalkylpolyether, quarternary ammonium terminated poly(dimethylsiloxane), an alkyl quarternary ammonuim complex, glass fibers, carbon fibers, carbon nanotubes, talc, mica, natural smectite clay, synthetic smectite clay, montmorillonite, saponite, hectorite, vermiculite, beidellite, or stevensite.

16. The method of claim 1, wherein the supercritical fluid comprises at least one of a hydrodcarbon, a cholrinated hydrocarbon, a fluorinated hydrocarbon, a chlorofluorohydrocarbon, an alcohol, a ketone, an ether, CO₂, H₂O, N₂, or O₂.

17. A system for forming a polymer nanocomposite, comprising:
a polymer-clay melt of a clay having a layered structure and a polymer; and
a supercritical fluid (SCF) in physical contact with the polymer-clay melt, wherein the clay, the polymer, and the SCF collectively satisfy |Sₚ−S_{scf}|>|S_{c}−S_{scf}| and |S_{c}−S_{scf}|≦2.0 (cal/cm³)^{0.5}, and wherein Sₚ is a solubility parameter of the polymer, S_{c} is a solubility parameter of the clay; and S_{scf} is a solubility parameter of the SCF.

18. The system of claim 17, wherein the SCF is subject to a pressure exceeding the critical pressure of the SCF and to a temperature exceeding the critical temperature of the SCF.

19. The system of claim 17, wherein the SCF is subject to a pressure less than the critical pressure of the SCF.

20. The system of claim 17, wherein the polymer-clay melt and the SCF are flowing together in a same direction.

21. The system of claim 20, further comprising an extruder, wherein the extruder includes a first region and second region, wherein the first region has a screw therein, wherein the second region extends from an end of the first region to an end of the extruder, and wherein the SCF is flowing within the first and second regions of the extruder.

22. The system of claim 21, wherein the SCF is subject to a pressure exceeding the critical pressure of the SCF and to a temperature exceeding the critical temperature of the SCF while flowing in the first region.

23. The system of claim 21, wherein the SCF is subject to a pressure exceeding the critical pressure of the SCF and to a temperature exceeding the critical temperature of the SCF while flowing in the second region.

24. The system of claim 21, wherein the SCF is subject to a pressure less than the critical pressure of the SCF while flowing in the second region.

25. The system of claim 21, wherein the SCF is subject to a pressure exceeding the critical pressure of the SCF and to a temperature exceeding the critical temperature of the SCF while flowing in the first and second regions.

26. The method of claim 17, wherein the polymer is selected from the group consisting of high density polyethylene, low density polyethylene, nylon 6, nylon 6, 6, poly(acrylonitrile), poly(ethylene terephthalate), poly(acetal), poly(propylene), polystyrene, poly(vinyl acetate-co-vinyl alcohol), poly(vinylidene chloride), poly(vinylidene fluoride), and poly(vinyl alcohol).

27. The method of claim 17, wherein the clay comprises at least one of an aliphatic fluorocarbon, perfluoroalkylpolyether, quarternary ammonium terminated poly(dimethylsiloxane), an alkyl quarternary ammonuim complex, glass fibers, carbon fibers, carbon nanotubes, talc, mica, natural smectite clay, synthetic smectite clay, montmorillonite, saponite, hectorite, vermiculite, beidellite, or stevensite.

28. The method of claim 17, wherein the supercritical fluid comprises at least one of a hydrodcarbon, a cholrinated hydrocarbon, a fluorinated hydrocarbon, a chlorofluorohydrocarbon, an alcohol, a ketone, an ether, CO₂, H₂O, N₂, or O₂.
